(19) United States
(12) Patent Application Publication
(10) Pub. No.: US 2025/0181920 A1
(43) Pub. Date: Jun. 5, 2025

(54) CLASSIFICATION TASKS FOR ENHANCING FAIRNESS-UTILITY TRADE-OFF USING ALEATORIC UNCERTAINTY

(71) Applicants: Anique Tahir, Tempe, AZ (US); Lu Cheng, Chicago, IL (US); Huan Liu, Tempe, AZ (US)

(72) Inventors: Anique Tahir, Tempe, AZ (US); Lu Cheng, Chicago, IL (US); Huan Liu, Tempe, AZ (US)

(73) Assignee: Arizona Board of Regents on Behalf of Arizona State University, Scottsdale, AZ (US)

(21) Appl. No.: 18/964,090

(22) Filed: Nov. 29, 2024

Related U.S. Application Data
(60) Provisional application No. 63/604,585, filed on Nov. 30, 2023.

(51) Int. Cl. G06N 3/084

(52) U.S. Cl. CPC G06N 3/084

(57) ABSTRACT

A method for training an artificial intelligence (AI) model includes receiving a training dataset and utilizing processing circuitry to train a Bayesian Neural Network (BNN) based on the dataset and a selected training algorithm including backpropagation. The method estimates aleatoric and epistemic uncertainty for each sample in the dataset. Based on these uncertainty estimates, weights are assigned to the samples, prioritizing those with lower aleatoric uncertainty. A conditioned training dataset is generated by increasing the weights of these prioritized samples. The AI model is then trained using this conditioned dataset. Finally, the pre-trained AI model outputs a prediction. This approach improves model performance by focusing on data with more predictable characteristics, reducing bias and enhancing prediction reliability.

### CLAIM OF PRIORITY

This application claims the benefit of U.S. Patent Application No. 63/604,585, filed 30 Nov. 2023, the entire contents of which is incorporated herein by reference.

### GOVERNMENT RIGHTS AND GOVERNMENT AGENCY SUPPORT NOTICE

This invention was made with government support under 2036127 awarded by the National Science Foundation. The government has certain rights in the invention.

### TECHNICAL FIELD

Aspects of the invention relate generally to the field of artificial intelligence and machine learning via computational systems and more particularly, to systems, methods, and apparatuses for implementing classification tasks.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

A Fairness-Utility Trade-off in the context of machine learning refers to the tension between optimizing models for fairness, which aims to avoid discrimination or bias against specific groups, and utility, which seeks high predictive accuracy. Increasing fairness may reduce overall accuracy, while maximizing utility may prioritize a majority group to the disadvantage of minority groups. This trade-off is particularly evident in classification tasks where biased training data or conflicting objectives exacerbate disparities. Fairness metrics such as demographic parity, equal opportunity, and equalized odds provide ways to evaluate equity, while utility metrics include accuracy, precision, and recall. However, these metrics often conflict, complicating efforts to achieve both fairness and utility.

Challenges include defining fairness in a way that aligns with ethical and regulatory demands, handling data limitations for underrepresented groups, and ensuring compliance with laws like GDPR. Real-world applications demonstrate the trade-off's complexity: in loan approvals, fairness may conflict with minimizing default risks; in hiring algorithms, equity must balance strong recommendations; and in healthcare diagnostics, addressing disparities across demographics must not undermine accuracy.

### SUMMARY

In general, this disclosure addresses systems, methods, and apparatuses for enhancing fairness-utility trade-off in classification tasks using aleatoric uncertainty. Situated at the intersection of machine learning, fairness, and predictive modeling, aspects of the disclosure address the challenge of achieving a balance between algorithmic fairness and predictive utility. Advancements in machine learning have transformed various domains; however, concerns about bias and unfairness in automated decision-making systems have received significant attention. A Guided Algorithm for Integrating Aleatory (GAIA) framework described herein addresses the concerns about bias while maintaining high predictive performance.

For instance, the GAIA framework balances the fairness-utility trade-off in classification tasks using aleatoric uncertainty. By employing the concept of aleatoric uncertainty, the GAIA framework enhances the trade-off between fairness and predictive performance. Aleatoric uncertainty refers to the inherent randomness or variability in data that cannot be reduced, even with more data or better models. Aleatoric uncertainty arises from factors including noise, ambiguity, or natural fluctuations within the dataset, and is often referred to as a measure of entropy within a dataset.

In at least one example, a method includes receiving, by processing circuitry, a training dataset. In at least one example, the method includes training, by the processing circuitry, a Bayesian Neural Network based on the training dataset and a selected training algorithm to generate a pre-trained artificial intelligence model. According to certain examples, the selected training algorithm includes backpropagation and weights for samples of the training dataset. In certain examples, the method includes applying, by the processing circuitry, the backpropagation within the Bayesian Neural Network to generate aleatoric uncertainty estimates and epistemic uncertainty estimates for the samples from the training dataset. In at least one example, the method includes assigning, by the processing circuitry, the weights to the samples from the training dataset based on the aleatoric uncertainty estimates and the epistemic uncertainty estimates for the samples from the training dataset. According to such examples, the method includes generating, by the processing circuitry, a conditioned training dataset by increasing the weights assigned to the samples having the aleatoric uncertainty estimates below a threshold. In one example, the method includes generating, by the processing circuitry, the pre-trained artificial intelligence model trained using the conditioned training dataset as input. In at least one example, the method includes outputting a prediction using the pre-trained artificial intelligence model.

In at least one example, a system includes processing circuitry; non-transitory computer readable media; and instructions that, when executed by the processing circuitry, configure the processing circuitry to: receive, by the processing circuitry, a training dataset. In at least one example, the system includes instructions that, when executed, configure the processing circuitry to train, by the processing circuitry, a Bayesian Neural Network based on the training dataset and a selected training algorithm to generate a pre-trained artificial intelligence model. According to certain examples, the selected training algorithm includes backpropagation and weights for samples of the training dataset. In at least one example, the system includes instructions that, when executed, configure the processing circuitry to apply, by the processing circuitry, the backpropagation within the Bayesian Neural Network to generate aleatoric uncertainty estimates and epistemic uncertainty estimates for the samples from the training dataset. In one example, the system includes instructions that, when executed, configure the processing circuitry to assign, by the processing circuitry, the weights to the samples from the training dataset based on the aleatoric uncertainty estimates and the epistemic uncertainty estimates for the samples from the training dataset. In certain examples, the system includes instructions that, when executed, configure the processing circuitry to generate, by the processing circuitry, a conditioned training dataset by increasing the weights assigned to the samples having the aleatoric uncertainty estimates below a threshold. According to at least one example, the system includes instructions that, when executed, configure the processing circuitry to generate, by the processing circuitry, the pre-trained artificial intelligence model trained using the conditioned training dataset as input. In one example, the system includes instructions that, when executed, configure the processing circuitry to output a prediction using the pre-trained artificial intelligence model.

In one example, there is computer-readable storage media having instructions that, when executed, configure processing circuitry to: receive a training dataset. In certain examples, the computer-readable storage media include instructions that, when executed, configure the processing circuitry to train a Bayesian Neural Network based on the training dataset and a selected training algorithm to generate a pre-trained artificial intelligence model. According to certain examples, the selected training algorithm includes backpropagation and weights for samples of the training dataset. In at least one example, the computer-readable storage media include instructions that, when executed, configure the processing circuitry to apply the backpropagation within the Bayesian Neural Network to generate aleatoric uncertainty estimates and epistemic uncertainty estimates for the samples from the training dataset. In one example, the computer-readable storage media include instructions that, when executed, configure the processing circuitry to assign the weights to the samples from the training dataset based on the aleatoric uncertainty estimates and the epistemic uncertainty estimates for the samples from the training dataset. In at least one example, the computer-readable storage media include instructions that, when executed, configure the processing circuitry to generate a conditioned training dataset by increasing the weights assigned to the samples having the aleatoric uncertainty estimates below a threshold. According to certain examples, the computer-readable storage media include instructions that, when executed, configure the processing circuitry to generate the pre-trained artificial intelligence model trained using the conditioned training dataset as input. In one example, the computer-readable storage media include instructions that, when executed, configure the processing circuitry to output a prediction using the pre-trained artificial intelligence model.

According to another example, there is a device comprising: means for receiving, by processing circuitry, a training dataset; means for training, by the processing circuitry, a Bayesian Neural Network based on the training dataset and a selected training algorithm to generate a pre-trained artificial intelligence model, wherein the selected training algorithm includes backpropagation and weights for samples of the training dataset; means for applying, by the processing circuitry, the backpropagation within the Bayesian Neural Network to generate aleatoric uncertainty estimates and epistemic uncertainty estimates for the samples from the training dataset; means for assigning, by the processing circuitry, the weights to the samples from the training dataset based on the aleatoric uncertainty estimates and the epistemic uncertainty estimates for the samples from the training dataset; means for generating, by the processing circuitry, a conditioned training dataset by increasing the weights assigned to the samples having the aleatoric uncertainty estimates below a threshold; means for generating, by the processing circuitry, the pre-trained artificial intelligence model trained using the conditioned training dataset as input; and means for outputting a prediction using the pre-trained artificial intelligence model.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of this disclosure.

FIGS. 2A-2B depict a block diagram illustrating use of the GAIA method, in accordance with aspects of this disclosure.

FIGS. 3A and 3B provide a comparison between different groups, in accordance with aspects of the disclosure.

FIG. 4 illustrates Table 1 which provides data demonstrating that GAIA framework provides an overall improvement over known baselines, in accordance with aspects of this disclosure.

FIG. 5 provides graphs showing the results of pruning uncertain samples from adult and German datasets, in accordance with aspects of this disclosure.

FIG. 6 is a flow diagram illustrating an example method for enhancing fairness-utility trade-off in classification tasks using aleatoric uncertainty, in accordance with one or more techniques of this disclosure.

Like reference characters denote like elements throughout the text and figures.

### DETAILED DESCRIPTION

In general, this disclosure addresses systems, methods, and apparatuses for enhancing fairness-utility trade-off in classification tasks using aleatoric uncertainty. Situated at the intersection of machine learning, fairness, and predictive modeling, aspects of the disclosure address the challenge of achieving a balance between algorithmic fairness and predictive utility. Advancements in machine learning have transformed various domains; however, concerns about bias and unfairness in automated decision-making systems have received significant attention. A Guided Algorithm for Integrating Aleatory (GAIA) framework described herein addresses the concerns about bias while maintaining high predictive performance.

For instance, the GAIA framework balances the fairness-utility trade-off in classification tasks using aleatoric uncertainty. By employing the concept of aleatoric uncertainty, the GAIA framework enhances the trade-off between fairness and predictive performance. Aleatoric uncertainty refers to the inherent randomness or variability in data that cannot be reduced, even with more data or better models. Aleatoric uncertainty arises from factors including noise, ambiguity, or natural fluctuations within the dataset, and is often referred to as a measure of entropy within a dataset.

An artificial intelligence model may be trained using samples with low aleatoric uncertainty to create pre-trained models that deliver more accurate and equitable results. To achieve this outcome, a systematic model intervenes in the data distribution to improve the distinction between aleatoric uncertainty and epistemic uncertainty. Epistemic uncertainty refers to the lack of knowledge or understanding within a machine learning model, often due to limited or incomplete data. Unlike aleatoric uncertainty, which stems from inherent randomness in the data, epistemic uncertainty arises from insufficient information or training. Unlike aleatoric uncertainty, epistemic uncertainty can be reduced by acquiring more data or improving model training. For instance, epistemic uncertainty may indicate the degree of data sufficiency required to support predictive outputs, based on the dataset size used for AI model training.

The GAIA framework may also utilize a fairness-utility bi-objective loss which is defined using estimated aleatoric uncertainty. For instance, GAIA framework may receive a training dataset; applying backpropagation within a Bayesian Neural Network (BNN) to separate aleatoric uncertainty from epistemic uncertainty in the training dataset; assigning weights to training dataset samples based on their estimated aleatoric uncertainty; producing a conditioned training dataset by increasing the weights assigned to samples with aleatoric uncertainty below a threshold to optimize the fairness-utility trade-off within the conditioned training dataset; and training an AI model using the conditioned training dataset as input to generate predictions.

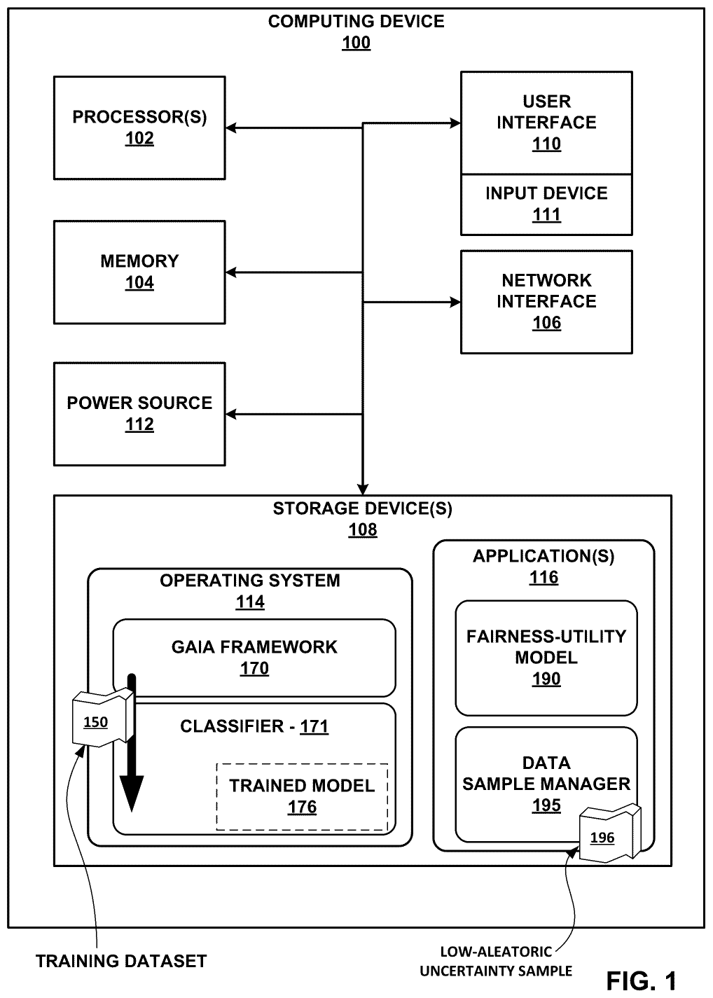

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

As shown in the specific example of FIG. 1, computing device 100 may include one or more processors 102, memory 104, a network interface 106, one or more storage devices 108, user interface 110, and power source 112. Computing device 100 may also include an operating system 114. Computing device 100, in one example, may further include one or more applications 116, fairness utility model 190 and data sample manager 195 configurable to operate in conjunction with GAIA framework 170. Data sample manager 195 may generate as output, low-aleatoric uncertainty sample 196.

Operating system 114 may execute various functions of GAIA framework 170 in conjunction with fairness utility model 190 and data sample manager 195 to enhance fairness-utility trade-off in classification tasks using aleatoric uncertainty using classifier 171 operating on training dataset 150. Trained model 176 and classifier 171 may be custom configurable using configuration settings.

In some examples, processing circuitry including one or more processors 105, implements functionality and/or process instructions for execution within computing device 100. For example, one or more processors 105 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 105. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include a network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

Computing device 100 may also include user interface 110. User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

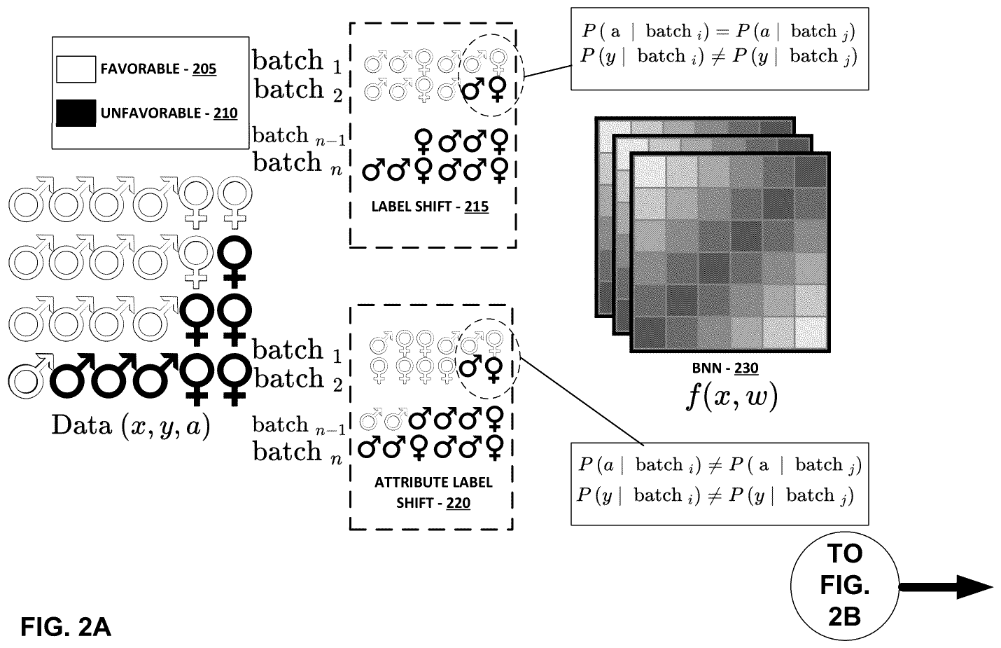

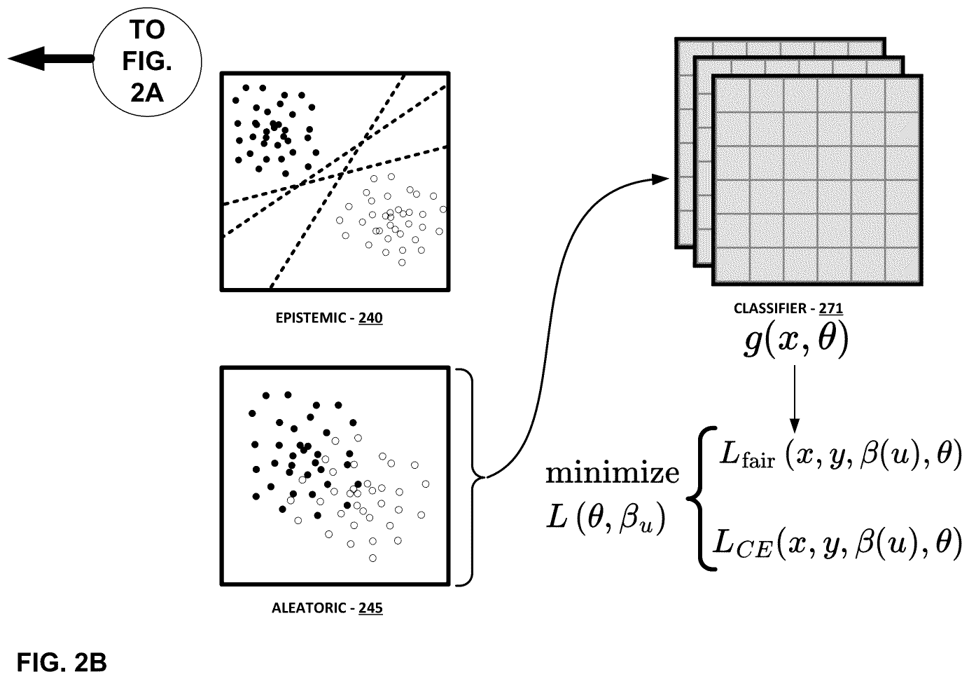

FIGS. 2A-2B depict a block diagram illustrating use of the GAIA method, in accordance with aspects of this disclosure. In some examples, after the distributional intervention is performed by computing device 100, the GAIA method improves the fairness-utility trade-off by balancing the utility (L_{CE}) and fairness (L_{fair}) loss using aleatoric uncertainty estimated by Bayesian Neural Networks.

In classification tasks, machine learning models may be utilized to accurately predict outcomes based on input data, such as training dataset 150. However, this pursuit of accuracy often neglects the potential for bias or discrimination against certain groups or individuals. Algorithmic fairness has emerged as a consideration, with the goal of ensuring that machine learning models make unbiased predictions across different demographic groups. Simultaneously, maximizing predictive utility remains a central objective to build effective and reliable machine learning systems.

Certain approaches to developing fairness-aware machine learning models focus on manipulating decision boundaries, re-weighting data, and/or imposing constraints on model outputs. Such approaches, while valuable, sometimes trade off predictive utility for fairness or vice versa. Striking a balance between these two objectives therefore provides an ongoing opportunity for improvement.

The concept of uncertainty in machine learning has also been considered. For instance, epistemic uncertainty reflects lack of knowledge for a model, often arising from limited data, whereas aleatoric uncertainty is attributed to inherent randomness or variability in the data itself. Leveraging these uncertainties for decision-making is a relatively unexplored area of research.

Aspects of the disclosure introduce purposeful use of aleatoric uncertainty to enhance fairness and utility simultaneously using GAIA framework 170 configurable to generate trained model 176 (e.g., a pre-trained model provided by GAIA framework 170). By recognizing that samples with low aleatoric uncertainty are more likely to lead to fair and accurate predictions, the techniques set forth herein provide an innovative methodology that leverages this underlying characteristic of the data.

Guided by the understanding that high aleatoric uncertainty can contribute to biased predictions, especially when combined with high epistemic uncertainty, aspects of the disclosure counteract the undesirable biased predictions by using a fairness-utility model 190 to intervene in the data distribution to disentangle such uncertainties. For instance, aspects of the disclosure may generate, as output from GAIA framework 170, trained model 176. Trained model 176 has been experimentally evaluated to perform well across both fairness and utility metrics, enhancing the overall performance of machine learning systems while ensuring equitable outcomes.

By integrating the principles of uncertainty with fairness-aware modeling, use of fairness-utility model 190 provides a fresh perspective on the intricate relationship between utility and fairness in machine learning. Benefits of the described methodologies are evident based on experimental results that demonstrate improved performance compared to state-of-the-art methods across various datasets.

In such a way, aspects of the disclosure address a challenge with prior known machine learning techniques by reconciling fairness and utility through the lens of aleatoric uncertainty via use of the fairness-utility model 190 and data sample manager 195 to create the low-aleatoric uncertainty sample 196. Such a multidisciplinary approach holds promise for revolutionizing how fairness and predictive performance are harmonized in automated decision-making systems going forward.

In some examples, processing circuitry of computing device 100 provides improved fairness through aleatoric uncertainty through the use of a comprehensive methodology that effectively addresses the challenges of achieving fairness and utility in classification tasks.

Problem Setting: The analysis considers the standard fair binary classification context, where the samples X∈ [symbol] ⊂ [symbol] ⁿ, labels Y∈ [symbol] ={0,1}, and protected attribute A∈{0,1} are provided as input. The objective is to train classifier 271 as g: [symbol] ⁿ→[0,1] such that the predictions Ŷ∈[0,1] by classifier 271 are accurate, meaning P(Ŷ|X)=P(Y|X), and fair across different demographic groups. The approach, referred to herein as Guided Algorithm for Integrating Aleatory (GAIA), leverages the relationship between fairness and aleatoric uncertainty arising from data ambiguity, which causes models to depend on biased priors. When aleatoric uncertainty is high, improving utility becomes challenging; however, fairness may still be improved since fairness enhancement does not inherently depend on utility. Empirical and theoretical evidence demonstrates that GAIA enhances the fairness-utility trade-off. The method includes three principal steps, detailed in subsequent subsections.

Distributional Intervention: Prior known machine learning algorithms may employ Empirical Risk Minimization (ERM) and rely on the assumption of independently and identically distributed (i.i.d.) data. Prior analyses have shown that distributional shifts exacerbate both fairness and predictive performance. Additionally, skewed distributions across protected groups make standard uncertainty estimation methods, such as Bayesian Neural Networks (BNNs) 230, ineffective for accurately estimating model uncertainty due to their sensitivity to data imbalance. To address this problem, adjustments are made to the data distribution by identifying two sources of data bias that can be controlled: (i) skewed label distribution, which causes the model to rely on the prior distribution of the label (label shift 215), and (ii) spurious correlation between the protected attribute and the label (attribute-label shift 220).

An example of skewed label distribution (label shift 215) occurs when most data instances carry a specific label, such as non-fraudulent transactions in fraud detection. In such cases, a trained model may rely on shortcut learning to predict the dominant label. Similarly, in attribute-label shift 220, the protected attribute may be significantly correlated with the label, leading the model to rely on this correlation during prediction. Furthermore, non-protected covariates affected by the protected attribute may also exhibit similar correlations.

Adjusting the relationship between the protected attribute and the label reduces the influence of protected attributes on non-protected covariates as well. Intervening in the distribution reduces unfairness and improves the disentanglement of uncertainty. GAIA framework 170 may be configured to replace this approach with different heuristics to achieve better utility and fairness outcomes depending upon the implementation needs. Effective heuristics reduce epistemic uncertainty, enabling more accurate estimates of aleatoric uncertainty.

Label Shift: Label shift 215 alters the label distribution in each mini-batch during training of trained model 176, leading to a model that does not disproportionately favor the dominant label in the original data distribution.

Formally, let (X,Y)∈ [symbol] represent instances in the training dataset 150 D, where X is the feature matrix and Y∈{0,1} is the binary label vector. The indices M₁={i∈ [symbol] |Yᵢ=1} and M₀={i∈ [symbol] |Yᵢ=0} correspond to samples with favorable 205 (e.g., low credit risk) and unfavorable 210 outcomes, respectively, where |M₁|=n₁ and |M₀|=n₀.

A random percentage p is sampled uniformly from [symbol] (0,1), and scaled index sets M₁′={i∈M₁|p} and M₀′={i∈M₀|1−p} are defined. These sets are used to compute the probabilities of selecting each sample,

$${P}_{{p}^{1} , i} = \frac{[ i ∈ {M}_{{p}^{1}}^{′} ]}{{n}_{{p}^{1}}} and {P}_{{p}^{0} , i} = \frac{[ i ∈ {M}_{{p}^{0}}^{′} ]}{{n}_{{p}^{0}}} .$$

A batch of size m is created by randomly selecting samples without replacement based on these probabilities, with the selected sample indices denoted by I={i₁, i₂, . . . , iₘ}⊂ [symbol] . This process produces a counterfactual batch of training samples with an intervened label distribution, referred to as LabelShift (LS) or Label Shift 215.

Attribute Label Shift: Intervening solely on the label distribution may be insufficient to address spurious correlations present in training dataset 150. Additional intervention on the protected attribute is necessary to mitigate its confounding effects. However, directly intervening on the protected attribute often proves infeasible with observational data. Application of attribute Label Shift 220 enables indirect intervention method is introduced by altering the correlation between the protected attribute and label distributions across different mini-batches during training.

Application of attribute Label Shift 220 assumes that the covariates contain a sufficient number of non-causal factors, enabling the interventional changes to be substantial enough for the model to differentiate between causal and non-causal factors. Attribute Label Shift 220 adjusts both the protected attribute a and the label y.

Let Mₚ_{¹}={i∈ [symbol] |aᵢ=1} and Mₚ_{⁰}={i∈ [symbol] |aᵢ=0} represent the indices of samples in the protected and non-protected groups, respectively, with cardinalities nₚ_{¹}=|Mₚ_{¹}| and nₚ_{⁰}=|Mₚ_{⁰}|. A random percentage p₁ is determined by sampling from the uniform distribution [symbol] (0,1). Scaled index sets Mₚ_{¹}′={i∈Mₚ_{¹}|p₁} and Mₚ_{⁰}′={i∈Mₚ_{⁰}|1−p} are then defined. The probabilities of selecting a sample from the protected or non-protected group are calculated as P_{p,i} for

$${P}_{{p}^{1} , i} = \frac{[ i ∈ {M}_{{p}^{1}}^{′} ]}{{n}_{{p}^{1}}} and {P}_{{p}^{0} , i} = \frac{[ i ∈ {M}_{{p}^{0}}^{′} ]}{{n}_{{p}^{0}}} .$$

Similarly, probabilities for selecting samples from the favored or unfavored class are defined as P_{f,i} for

$${P}_{1 , i} = \frac{[ i ∈ {M}_{1}^{′} ]}{{n}_{1}} and {P}_{0 , i} = \frac{[ i ∈ {M}_{0}^{′} ]}{{n}_{0}} .$$

The final probability for selecting each sample is the product Pᵢ=P_{p,i}*P_{f,i}. This process generates a batch of training samples with adjusted correlations between the protected attribute and label, referred to as Attribute Label Shift (ALS) 220.

Decoupling Aleatoric and Epistemic Uncertainty: The Guided Algorithm for Integrating Aleatory (GAIA) employs Bayesian Neural Networks (BNNs) 230 via backpropagation, commonly referred to as Bayes by Backprop, to separate aleatoric 245 uncertainty from epistemic 240 uncertainty. This method integrates seamlessly into existing neural architectures using GAIA framework 170 while maintaining computational efficiency and theoretical rigor. For C classes, aleatoric 245 uncertainty is expressed as the expected entropy of the model's predictions, as described in Equation 1, set forth below, as follows:

$${H}_{alea} ( x ) = {\int }_{θ} {\sum }_{i}^{C} - p ( {y}_{i} \vert x , θ ) log p ( {y}_{i} \vert x , θ ) d θ ,$$

where p(yᵢ|x,θ) represents the predictive probability for the i-th class given model parameters θ. Epistemic 240 uncertainty, on the other hand, is measured as the model's predictive variance, as defined in Equation 2, set forth below, as follows:

$${σ}_{epi}^{2} ( x ) = {Var}_{j} [ p ( y \vert x , {θ}_{j} ) ] ,$$

where j refers to the j-th sample of the weights of BNN 230. BNNs 230 determine the maximum a posteriori (MAP) weights using Equation 3 set forth below, as follows:

$${θ}^{MAP} = {arg max}_{θ} log P ( θ \vert 𝒟 ) = {arg max}_{θ} P ( 𝒟 \vert θ ) + log P ( θ ) .$$

The final prediction of BNN 230 is the expected value of the predicted label ŷ for an unseen sample \hat{x}, averaged over the posterior distribution of the weights P(θ| [symbol] ) i.e., P(ŷ|\hat{x})= [symbol] _{P(θ|} [symbol] ₎[P(ŷ|\hat{x},θ)]. By utilizing candidate predictions P(ŷ|\hat{x},θⱼ), where θⱼ˜P(θ| [symbol] ), both aleatoric 245 and epistemic 240 uncertainties are efficiently evaluated through Equations 1 and 2, respectively.

For tractable estimation, variational inference typically approximates the posterior using a surrogate distribution q(θ|w), minimizing the Evidence Lower Bound (ELBO) loss. This method assumes heteroscedastic uncertainty, where the uncertainty varies across samples, aligning with real-world applicability. Consequently, uncertainty metrics are computed on a per-sample basis. By explicitly modeling aleatoric and epistemic uncertainty, GAIA framework 170 identifies whether uncertainty arises from data ambiguity or insufficient data.

Improving the Fairness-Utility Trade-off: In the example of FIGS. 2A-2B, processing circuitry of computing device 100 operates on both favorable data and unfavorable data (e.g., x, y, a), distributed across batches 1-n. GAIA framework 170 leverages aleatoric 245 uncertainty to balance fairness and accuracy. Samples with low aleatoric 245 uncertainty are more effectively modeled for both accuracy and fairness compared to those with high uncertainty. To achieve an improved balance, GAIA framework 170 enhances fairness in cases of high aleatoric uncertainty while prioritizing utility in other scenarios.

To this end, a weighting function β(u): [symbol] ^{m}→ [symbol] ^{m} is introduced to assign weights to samples based on their estimated aleatoric uncertainty u, as defined in Equation 4, set forth below, as follows:

$$β ( u ) = {( \frac{u - {u}_{min}}{{u}_{max} - {u}_{min}} )}^{k} .$$

The hyperparameter k governs the emphasis on one objective over the other, while uₘᵢₙ and uₘₐₓ are normalization parameters for the uncertainty weights. The overarching objective function of GAIA framework 170 (see Equation 7 below) is a bi-objective loss that combines utility and fairness. For samples with low aleatoric 245 uncertainty, utility is maximized. Conversely, for those with high aleatoric 245 uncertainty, limited gains can be made in utility due to inherent data ambiguity, shifting the focus toward improving fairness.

For a batch of training data [symbol] ⊆ [symbol] and a classifier parameterized by θ, utility loss is defined as a weighted cross-entropy loss in Equation 5, set forth below, as follows:

$${ℒ}_{CE} ( , β ) = - \frac{1}{\vert \vert} {β}_{i} ( {y}_{i} log ( p ( {y}_{i} \vert {x}_{i} , {u}_{i} ) ) + ( 1 - {y}_{i} ) log ( 1 - p ( {y}_{i} \vert {x}_{i} , {u}_{i} ) ) ) ,$$

where yᵢ denotes the label for sample xᵢ and βᵢ=β(uᵢ). By conditioning predictions p(yᵢ|xᵢ,uᵢ), on aleatoric 245 uncertainty, the model can make more informed decisions. Fairness is quantified as the difference in the mean cross-entropy between samples with different protected attributes. This fairness metric serves as a practical surrogate to capture widely used group fairness metrics. Let [symbol] ₀ and [symbol] ₁ represent the sets of samples with protected attributes of 0 and 1, respectively. Fairness is then defined as shown in Equation 6, set forth below, as follows:

$${ℒ}_{fair} ( , 1 - β ) = \vert {ℒ}_{CE} ( {0}_{} , 1 - β ) - {ℒ}_{CE} ( {1}_{} , 1 - β ) \vert {0}_{} ⋃ {1}_{} = .$$

The overall objective function of GAIA, denoted L, is the sum of the utility loss (see Equation 5) and fairness loss (see Equation 6), as described in Equation 7, set forth below, as follows:

$$ℒ ( , β ) = {ℒ}_{CE} ( , β ) + {ℒ}_{fair} ( , 1 - β ) .$$

Theoretical Guarantee to Improve the Trade-Off: Guided Algorithm for Integrating Aleatory (GAIA), as implemented by GAIA framework 170, enables an improvement to the fairness-accuracy trade-off. The analysis is grounded in three hypotheses: (i) as aleatoric 245 uncertainty increases, accuracy diminishes; (ii) fairness can be improved in regions characterized by high aleatoric 245 uncertainty; and (iii) the binary cross-entropy (BCE) difference between protected groups, as defined in Equation 6 above, is proportional to common group fairness metrics, such as equal opportunity difference (EOD) and average odds difference (AOD).

The proof is structured around two propositions: first, the divergence of optimal utility under aleatoric 245 uncertainty is demonstrated, followed by the convergence of fairness as measured by BCE differences across protected and non-protected groups. For simplicity and alignment with the problem setting, the binary classification case is considered. AOD is used as an illustrative metric, but the approach generalizes to others, including EOD.

Relation between Aleatoric Uncertainty and Accuracy—Theorem 3.1: As aleatoric 245 uncertainty increases, the accuracy of the model converges toward random chance. This result is formally stated in Theorem 3.1, set forth below, as follows:

$${lim}_{𝔼 [ H [ q ( y \vert x ) ] ] \to inf} accuracy = \frac{1}{C} ,$$

where C denotes the number of classes.

Proof of Theorem 3.1: The proof begins with the definition of predictive entropy for the model. Let p(y|x) represent the predicted probability distribution for the target class y given the input instance x. In the context of binary classification, where y∈{0,1}, the expected predictive entropy is calculated as the average predictive entropy across all instances in the dataset, capturing the aleatoric uncertainty (as specified in Equation 1 above).

To establish that accuracy approaches random chance as predictive entropy increases, a lower bound on accuracy is derived using Fano's inequality. In binary classification, random chance corresponds to an accuracy of ½, suggesting that the model is not better than random guessing. Fano's inequality connects the conditional probability of error when predicting the target class y based on the input instance x to the mutual information between y and x.

The relationship is summarized in Lemma 3.2, set forth below, as follows:

$$H ( ϵ ) + ϵlog ( C - 1 ) \geq H ( Y \vert X ) ,$$

where H(ϵ) denotes the binary entropy function of ϵ, the probability of error in predicting the target class, and H(Y|X) is the conditional entropy of the true conditional probability distribution. For binary classification (C=2), Fano's inequality simplifies according to Equation 8, set forth below, as follows:

$$H ( ϵ ) + ϵlog ( 1 ) \geq H ( Y \vert X ) .$$

Since log(1)=0, the inequality reduces further, according to Equation 9, set forth below, as follows:

$$H ( ϵ ) \geq H ( Y \vert X ) .$$

The probability of error E relates to accuracy, according to Equation 10, set forth below, as follows:

$$ϵ = 1 - Accuracy .$$

Substituting relationship into Fano's inequality yields Equation 11, set forth below, as follows:

$$H ( 1 - Accuracy ) \geq H ( Y \vert X ) .$$

The binary entropy function H(p) is known to increase monotonically for 0≤p≤½ 0≤p≤½ and decrease monotonically for 0≤p≤½. Maximum entropy is achieved when p=½. Therefore, the entropy of the error probability is maximized

when the accuracy is at random chance, according to Equation 12, set forth below, as follows:

$$H ( 1 - 1 / 2 ) = H ( 1 / 2 ) = 1.$$

As the expected predictive entropy [symbol] [H[q(y|x)]] increases, the lower bound on accuracy determined by Fano's inequality converges toward this maximum entropy state. Consequently, the model's performance becomes indistinguishable from random chance as aleatoric uncertainty rises.

Relation Between BCE Loss Difference and Fairness—Theorem 3.3: The expected difference in Binary Cross-Entropy (BCE) losses between the protected and non-protected groups, as defined in Equation 6 above, is proportional to the Average Odds Difference (AOD). Theorem 3.3 is set forth below, as follows:

$$𝔼 [ Δ L ( y ) ] = \frac{1}{{N}_{1}} {\sum }_{i ∈ {A}_{1}} Δ L ( {y}_{i} ) - \frac{1}{{N}_{2}} {\sum }_{j ∈ {A}_{2}} Δ L ( {y}_{j} ) ∝ AOD .$$

Proof of Theorem 3.3: Protected attribute instances are denoted as A₁ and A₂. Let pᵢ represent the predicted probability of the positive class (y=1) for instances in the group with the protected attribute Aᵢ, where i∈{1,2}.

Proposition 3.1: The BCE loss for instances with the protected attribute Aᵢ is given, as follows:

$${L}_{i} ( y , {p}_{i} ) = - y log ( {p}_{i} ) - ( 1 - y ) log ( 1 - {p}_{i} ) .$$

The proposition is derived directly from the BCE definition for binary classification. Group fairness metrics focus on the differences in True Positive Rates (TPRᵢ) and False Positive Rates (FPRᵢ).

Lemma 3.4 (Average Odds Difference): The Average Odds Difference (AOD) between group A₁ and group A₂ is given, as follows:

$$AOD = \frac{\vert {TPR}_{1} - {TPR}_{2} \vert + \vert {FPR}_{1} - {FPR}_{2} \vert}{2} .$$

Analyzing the BCE loss difference for the protected (L₁(⋅)) and non-protected (L₂(⋅)) groups provides insight into fairness.

Lemma 3.5: The difference in BCE losses between the two groups can be expressed mathematically, as follows:

$$Δ L ( y ) = {L}_{1} ( y , {p}_{1} ) - {L}_{2} ( y , {p}_{2} ) = - y log ( \frac{{p}_{1}}{{p}_{2}} ) - ( 1 - y ) log ( \frac{1 - {p}_{1}}{1 - {p}_{2}} ) .$$

Let N₁ and N₂ denote the total number of instances in the protected A₁ and non-protected A₂, groups, respectively. To validate Theorem 3.3, the expected differences in BCE losses are calculated separately for true positive and false positive cases.

Equal Opportunity Difference and BCE Difference: In true positive cases y=1, the BCE loss difference

$$Δ L ( y = 1 ) = - log ( \frac{{p}_{1}}{{p}_{2}} ) ,$$

as derived from Lemma 3.5. The expected difference in BCE losses for true positives across groups is represented in Equation 13, set forth below, as follows:

$$\begin{matrix}𝔼 [ Δ L ( y = 1 ) ] = \frac{1}{{N}_{1}} {\sum }_{i ∈ {A}_{1} , {y}_{i} = 1} - log ( \frac{{p}_{1}}{{p}_{2}} ) - \frac{1}{{N}_{2}} {\sum }_{j ∈ {A}_{2} , {y}_{j} = 1} - log ( \frac{{p}_{1}}{{p}_{2}} ) \\ ∝ \vert {TPR}_{1} - {TPR}_{2} \vert = EOD .\end{matrix} .$$

Average Odds Difference and BCE Difference: In false positive cases y=0, the BCE loss difference

$$Δ L ( y ) = - log ( \frac{1 - {p}_{1}}{1 - {p}_{2}} ) .$$

The expected difference in BCE losses for false positives across groups is represented in Equation 14, set forth below, as follows:

$$\begin{matrix}𝔼 [ Δ L ( y = 0 ) ] = \frac{1}{{N}_{1}} {\sum }_{i ∈ {A}_{1} , {y}_{i} = 0} - log ( \frac{1 - {p}_{1}}{1 - {p}_{2}} ) - \\ \frac{1}{{N}_{2}} {\sum }_{j ∈ {A}_{2} , {y}_{j} = 0} - log ( \frac{1 - {p}_{1}}{1 - {p}_{2}} ) \\ ∝ \vert {FPR}_{1} - {FPR}_{2} \vert\end{matrix} .$$

Combining the expected differences for true positive (Equation 13) and false positive cases (Equation 14) with Lemma 3.4 leads to Equation 15, set forth below, as follows:

$$\begin{matrix}𝔼 [ Δ L ( y ) ] = 𝔼 [ Δ L ( y = 1 ) ] + 𝔼 [ Δ L ( y = 0 ) ] \\ ∝ \vert {TPR}_{1} - {TPR}_{2} \vert + \vert {FPR}_{1} - {FPR}_{2} \vert = AOD \times 2\end{matrix} .$$

Equation 15 demonstrates that the expected BCE loss difference between the protected and non-protected groups is proportional to the AOD. Consequently, reducing the BCE loss difference contributes to improved fairness in terms of AOD. Equal Opportunity Difference (EOD) is a subset of AOD, as shown in Equation 13 above.

Equation 13 and Equation 15 are further examined for clarity. From Lemma 3.5, in true positive cases (y=1), the BCE loss difference

$$Δ L ( y = 1 ) = - log ( \frac{{p}_{1}}{{p}_{2}} )$$

reflects the relationship between BCE loss and TPR. The total number of true positive instances for each group is denoted as N₁^{TP} and N₂^{TP}, with TPR₁ and TPR₂ representing the true positive rates for A₁ and A₂, respectively. The expected BCE loss difference for true positives is expressed in Equation 16, set forth below, as follows:

$$\begin{matrix}𝔼 [ Δ L ( y = 1 ) ] = \frac{1}{{N}_{1}^{TP}} {\sum }_{i ∈ {A}_{1} , {y}_{i} = 1} - log ( \frac{{p}_{1}}{{p}_{2}} ) - \\ \frac{1}{{N}_{2}^{TP}} {\sum }_{j ∈ {A}_{2} , {y}_{j} = 1} - log ( \frac{{p}_{1}}{{p}_{2}} )\end{matrix} .$$

Reformulating Equation 16 using TPR values leads to Equation 17, set forth below, as follows:

$$\begin{matrix}𝔼 [ Δ L ( y = 1 ) ] = \frac{1}{{TPR}_{1} {N}_{1}} {\sum }_{i ∈ {A}_{1} , {y}_{i} = 1} - log ( \frac{{p}_{1}}{{p}_{2}} ) - \\ \frac{1}{{TPR}_{2} {N}_{2}} {\sum }_{j ∈ {A}_{2} , {y}_{j} = 1} - log ( \frac{{p}_{1}}{{p}_{2}} )\end{matrix} .$$

Equation 17 indicates that as the difference between TPR₁ and TPR₂ increases, [symbol] [ΔL(y=1)] also increases. Thus, significant TPR differences result in greater BCE loss dissimilarities between groups. Similarly, the expected BCE loss difference for false positive cases [symbol] [ΔL(y=1)] is proportional to the difference in TPR between the two protected attribute groups. Similarly, the proportionality of the expected difference in BCE losses for false positive cases, [symbol] [ΔL(y=0)], the difference in FPR between the groups is established. Combining the results for true positive and false positive cases, it is demonstrated that expected differences in BCE losses between the two protected attribute groups is proportional to the AOD, as stated in Theorem 3.3. In other words, the expected difference in BCE losses for true positive cases captures the difference in TPR and FPR between the two protected attribute groups, which is a component of common group fairness metrics such as EOD and AOD.

Fairness-Utility Trade-off: Under Theorem 3.3, minimizing the BCE loss difference in regions characterized by high aleatoric uncertainty indirectly enhances group fairness. Reducing BCE loss diminishes disparities between groups, particularly in regions where model predictions are more prone to biases and disparities due to reliance on learned priors. This phenomenon often leads to unfair predictions. By emphasizing fairness in these regions, it is possible to mitigate the adverse impact of aleatoric uncertainty on marginalized groups. However, as established in Theorem 3.1, enhancing accuracy in such regions is infeasible.

In contrast, for regions of high confidence, characterized by low uncertainty, accuracy converges to 1 according to the law of large numbers. In these scenarios, fairness is naturally improved as utility is optimized. As indicated by Lemma 3.4 and equation 18, fairness and utility are interconnected in such regions. Equation 18 is set forth below, as follows:

$$\begin{matrix}{lim}_{accuracy \to 1} AOD = \frac{\vert {TPR}_{1} - {TPR}_{2} \vert + \vert {FPR}_{1} - {FPR}_{2} \vert}{2} \\ = \frac{\vert 1 - 1 \vert + \vert 0 - 0 \vert}{2} = 0\end{matrix} .$$

Theorems 3.1 and 3.3 suggest that GAIA focuses on improving utility and fairness in the respective regions where the two metrics do not conflict. This application of GAIA by GAIA framework 170 reduces the fairness-utility trade-off, leading to advancements in both metrics simultaneously.

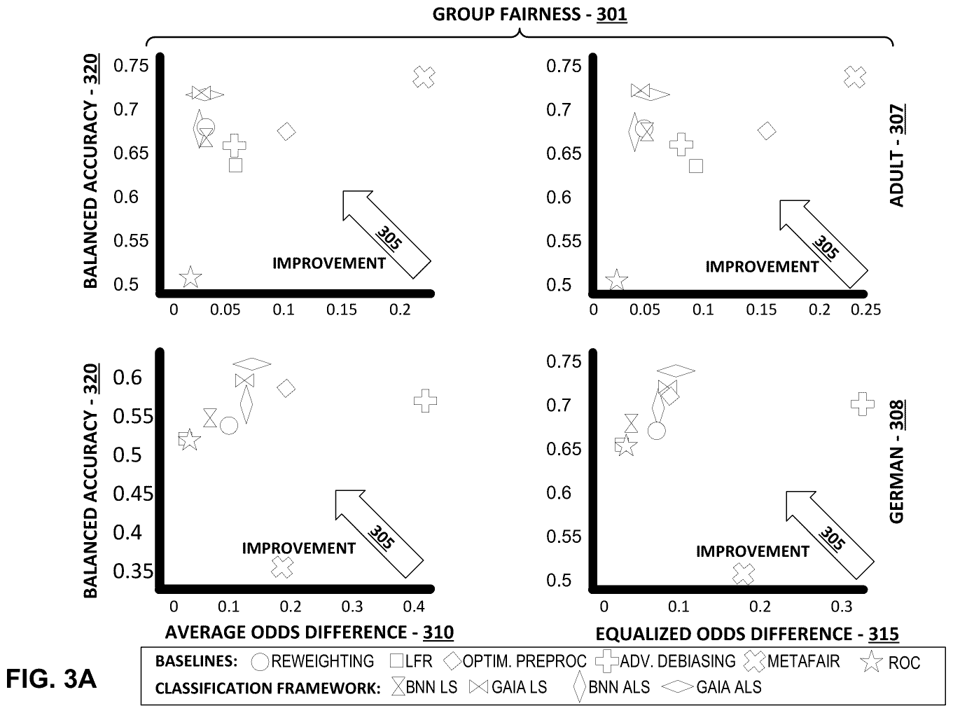

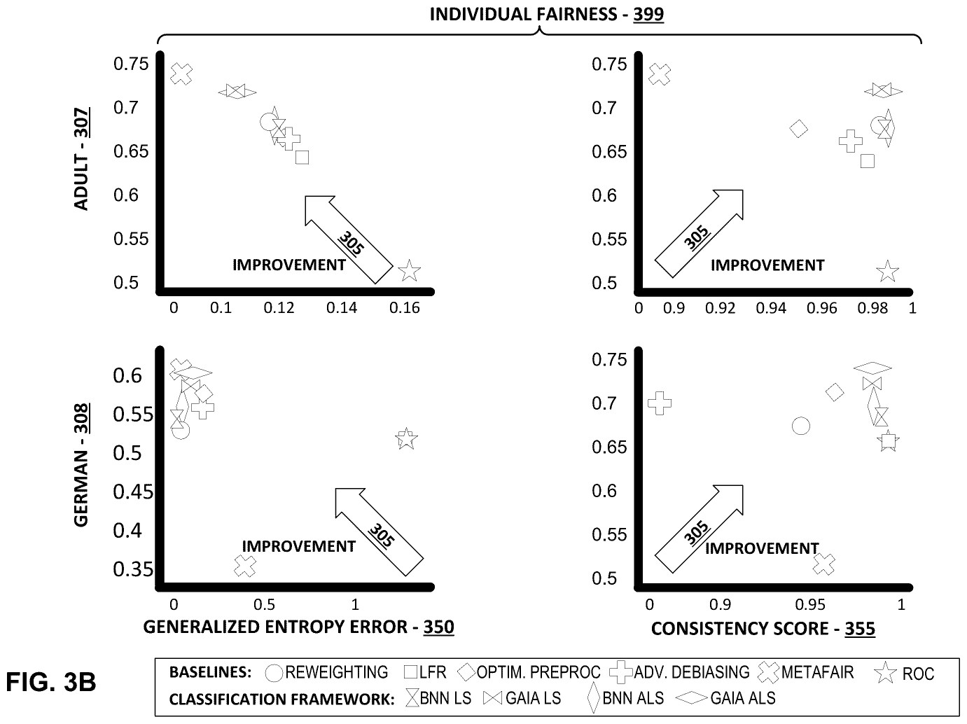

FIGS. 3A and 3B provide a comparison between different groups, in accordance with aspects of the disclosure. In particular, FIG. 3A provides a comparison of group fairness for adult and German datasets and FIG. 3B provides a comparison of individual fairness for adult and German datasets. Various approaches fall on different places on the Pareto front representing the fairness-utility trade-off.

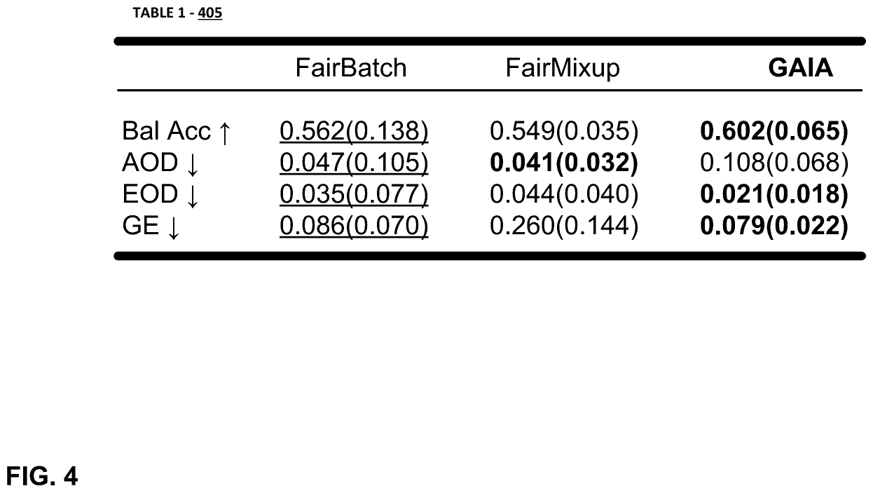

FIG. 4 illustrates Table 1, set forth at element 405, which provides data demonstrating that GAIA framework 170 provides an overall improvement over known baselines, in accordance with aspects of this disclosure.

### EXPERIMENTS

Described techniques show empirical evidence of the effectiveness of GAIA and provide answers to the following research questions: First research question: “How does GAIA fare against the state-of-the-art baselines in terms of the fairness-utility trade-off?” Second research question: “How does empirical evidence support the hypothesis regarding aleatoric uncertainty, fairness, and utility?” And third research question: “While designed for group fairness, what role does GAIA play in improving individual fairness?”

### Experimental Setup:

Experiments were conducted using both tabular and image datasets. For tabular data, GAIA was compared with seven baseline methods, including common pre-processing, in-processing, and post-processing approaches. Two benchmark tabular datasets were used, along with four fairness metrics that encompass both group and individual fairness. Specifically, for research questions 1 and 2, the group fairness metrics EOD and AOD were used. Generalized Entropy Error (GE) and Consistency Score (CS) were used to measure individual fairness for research question 3. For the utility measure, balanced accuracy was employed, as it is conventionally used for fairness evaluations due to its ability to capture balanced protected groups. For the image classification task, one benchmark dataset and two additional state-of-the-art approaches were used as baselines to validate the generalizability of GAIA.

### Datasets:

The benchmark tabular datasets and image dataset for fair machine learning are described below, as follows:

Adult: This dataset includes various features, such as work class, age, education, and sex. Each instance has a binary label based on whether an individual's income exceeds $50,000 per year. The dataset contains 48,842 samples.

German: This dataset includes features related to the financial status of individuals. The label represents whether the attributes indicate a good or bad credit risk. The dataset contains 1,000 samples.

CelebA: This dataset contains aligned faces of celebrities, annotated with various attributes, such as gender, age, expression, hair type, and attractiveness. It contains 202,599 face images from 10,177 celebrities. Gender was considered the protected attribute in each dataset. Features in tabular datasets were binarized, preprocessed, and scaled.

Baselines: For tabular data, GAIA was compared against seven well-established baseline approaches. These approaches were categorized into pre-processing, in-processing, and post-processing methods.

Reweighting: Reweighting is a pre-processing approach that adjusts the weight assigned to examples in each (group, label) pairing to promote fairness prior to classification.

Learning Fair Representations (LFR): LFR is a pre-processing technique that aims to discover a latent representation that effectively encodes the data while concealing information pertaining to protected attributes.

Optimized Preprocessing: Optimized preprocessing is a pre-processing approach that employs a probabilistic transformation to modify both features and labels in the data, considering fairness with respect to groups, minimizing individual distortion, and preserving data integrity.

Adversarial Debiasing: Adversarial debiasing is an in-processing technique that trains a classifier to achieve high prediction accuracy while simultaneously reducing the adversary's capacity to infer protected attributes from the predictions. This results in a fair classifier, as the predictions are devoid of any group discrimination information that could be leveraged by the adversary.

MetaFair: MetaFair is an in-processing meta-algorithm for fair classification that handles a broad range of fairness constraints, including non-convex linear fractional constraints such as predictive parity.

Calibrated Equalized-Odds: Calibrated equalized-odds is a post-processing technique that uses calibrated predicted scores to adjust the labels towards better equalized odds.

Reject Option Classification (ROC): ROC is a post-processing technique that balances favorable outcomes between privileged and unprivileged groups by altering the decision boundary in regions of the highest uncertainty.

To further examine the effectiveness of the incorporated aleatoric uncertainty, GAIA framework 170 was compared against two sub-module variants: BNN LS, which is the uncertainty estimation component where a BNN is trained using Label Shift, and BNN ALS, where the BNN is trained using Attribute Label Shift.

The baseline methods for tabular data were not designed for image modality. Therefore, for fair comparisons, two state-of-the-art approaches for fair image classification were considered:

FairBatch: FairBatch seeks to improve the batch selection process through bi-level optimization to ensure the downstream model achieves improved fairness.

FairMixup: FairMixup uses data augmentation to improve the fairness-utility tradeoff by making the underlying model more generalizable through regularization on interpolates.

Implementation Details: For simplicity, a logistic regression model was employed by the experiments, which is a multi-layer perceptron (MLP) without any hidden layers. The uncertainties used for training the classification model were generated using a BNN that consisted of three hidden layers. The activation functions used for the BNN and MLP were LeakyReLU and ReLU, respectively. The Adam optimizer was used as needed. Both the BNN and MLP were designed using the JAX framework and Oryx for sampling from distributions. For image classification, ResNet-18 was used as the backbone for both the BNN and the final classifier.

The best model was selected from training, using a simple approach. During the training phase, between each mini-batch, the smoothed training prediction accuracy was calculated using a running average. The model parameters corresponding to the best-smoothed accuracy during training are selected for inference. For the baselines, standard implementations provided by the AI Fairness 360 Toolkit were used, with the recommended hyperparameters where needed. For the image baselines, the open-source code for the respective baseline methodologies were utilized.

### Experimental Results:

Tabular Data: The experimental results for Research Question 1 (RQ1) examine the trade-off between model utility and fairness. FIG. 2A visualizes the comparison of Pareto fronts concerning group fairness 301. The model demonstrates Pareto dominance in most cases overall. Observations reveal that in-processing approaches, such as Adversarial Debiasing and MetaFair, emphasize fairness over utility. In contrast, pre-processing methods (Reweighting, LFR, Optimized Preprocessing) and post-processing methods (Calibrated Equalized Odds difference 315 and ROC) offer a more balanced accuracy 320 and thus, a more balanced trade-off. Differences in trade-offs are also evident across the Adult 307 and German 308 datasets, likely influenced by variations in sample sizes. The Adult 307 dataset, consisting of approximately 48,000 samples, is significantly larger than the German 308 dataset, which contains 1,000 samples. This discrepancy may contribute to the distinct performance of methods regarding the fairness-utility trade-off.

In the Adult 307 dataset, performance differences between the approaches using Label Shift (LS) and Attribute Label Shift (ALS) are minimal. This outcome may be attributed to the larger dataset size, which enables better generalization and reduced uncertainty. As a result, the shift applied during Bayesian Neural Network (BNN) training has less influence. Conversely, the German 308 dataset exhibits more diverse performance. ALS counterparts for both BNN and GAIA demonstrate superior utility compared to LS, although LS counterparts exhibit slightly better fairness. This may occur because LS versions approach random chance, which treats instances of the protected attribute more uniformly, increasing fairness. For GAIA LS and GAIA ALS variants provided by GAIA framework 170, the disparity in fairness is less pronounced, as both versions perform better than random chance.

FIGS. 2A-2B also highlight the value of uncertainty-guided training by GAIA framework 170, which integrates utility and fairness objectives using a weighted sum. While BNN approaches with distribution shift (BNN LS and BNN ALS) achieve competitive performance relative to baselines, GAIA framework 170 consistently surpassed BNN in utility while maintaining comparable fairness. This improvement 305 is more noticeable in the Adult 307 dataset, where the larger sample size allows GAIA framework 170 to exploit disparities between ambiguous and non-ambiguous data subsets. These results emphasize the ability of GAIA framework 170 to enhance the fairness-utility trade-off for RQ1.

Image Data: To evaluate the generalizability of the approach, performance of GAIA framework 170 was also assessed in the image domain using the Celebrity Faces dataset (CelebA). The Consistency Score 355 for fair image classification was not reported, as pixel-level consistency distances in image data are influenced by spurious features, such as backgrounds. Results are summarized in Table 1 (see FIG. 4).

In multi-objective optimization, an outcome is considered Pareto dominant if both utility and fairness improve. GAIA framework 170 demonstrates Pareto dominance over FairMixup and FairBatch for all fairness metrics except for Average Odds Difference 310 (AOD) as depicted by FIG. 3A. FairBatch achieves Pareto dominance in the same metrics over FairMixup. Although FairMixup is not Pareto dominant for AOD due to lower accuracy, it exhibits superior AOD performance. This may occur because its predictions are closer to random chance, which is considered fair under AOD. FairBatch employs meta-optimization of the batch selection process to train the model fairly. GAIA framework 170 utilizes a similar strategy by adjusting batch selection through Label Shift (LS) and Attribute Label Shift (ALS). However, while GAIA explicitly modifies label distributions and attribute-label correlations, FairBatch incorporates an outer loss function to optimize batch selection during training.

Moreover, GAIA framework 170 leverages uncertainty awareness, enabling informed predictions that enhance the trade-off between utility and fairness. FairMixup, in contrast, relies on data augmentation. The counterfactuals generated through interpolation during data augmentation may not represent real-world scenarios. By modifying the batch selection process, both FairBatch and GAIA framework 170 ensure that each sample originates from actual training data. Although the data distribution shifts, each sample remains authentic. This distinction accounts for the superior performance of FairBatch and GAIA framework 170 compared to FairMixup.

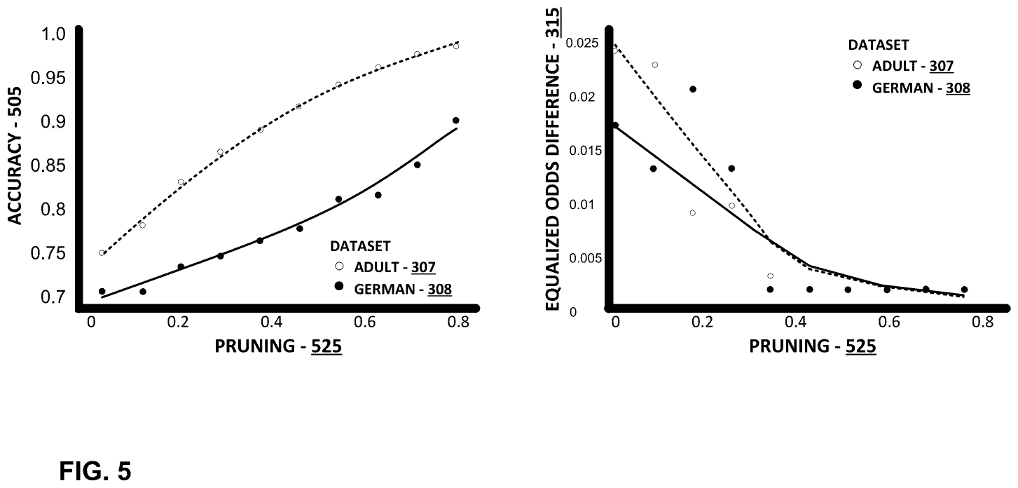

FIG. 5 provides graphs showing the results of pruning uncertain samples from adult and German datasets, in accordance with aspects of this disclosure.

Aleatoric Uncertainty and its Impact on Utility and Fairness: Additional experiments were conducted on tabular data to demonstrate that samples with high aleatoric uncertainty contribute significantly to algorithmic unfairness and prediction errors. The experiments examined how GAIA framework 170 performs in terms of utility and fairness when samples with high aleatoric uncertainty are removed (RQ2).

As depicted by FIG. 5, improvements in accuracy 505 and Equalized Odds Difference (EOD) 315 were observed in both the adult 307 and German 308 datasets, as the most uncertain predictions were filtered out via pruning 525.

Group fairness 301 metrics (see FIGS. 2A-2B), such as Equalized Odds Difference 315 and Average Odds Difference 310, measure the difference between the True Positive Rate (TPR) and the False Positive Rate (FPR). When predictions perfectly align with ground truth, these metrics converge to 1 and 0, respectively, for all instances within the protected group. Consequently, filtering high-uncertainty samples leads to enhanced accuracy and fairness. By focusing on samples with the most confident predictions, the probability of achieving improvements in both utility and fairness increases. This finding provides robust empirical support for the primary hypothesis, which centers on distinguishing samples by aleatoric uncertainty to shift focus between fairness and utility.

Individual Fairness: The fairness notion employed in this context is influenced by group fairness 301 metrics (see FIGS. 2A-2B), as it optimizes the cross-entropy difference for individual instances of the protected attribute. This raises concerns regarding its relevance to individual fairness 399 (see FIG. 2B) with respect to research question 3 (RQ3). However, empirical results from tabular data (see FIG. 3B) and image data (see Table 1 at FIG. 4) reveal that GAIA framework 170 performs effectively in the fairness-utility trade-off, even when individual fairness 399 metrics (see FIG. 2B) are emphasized.

To understand these outcomes, the distinction between regions of high and low aleatoric uncertainty and the two individual fairness metrics is considered. Specifically, the distinction between Generalized Entropy Error (GE) 350 (see FIG. 3B) and Consistency Score (CS) 355 (see FIG. 3B). Generalized entropy error 350 quantifies the entropy index within each group. When aleatoric uncertainty is low within a group, predictions closely align with ground truth for individual samples due to increased confidence, which enhances the likelihood of accurate predictions. In contrast, under high aleatoric uncertainty, GAIA framework 170 prioritizes equalizing cross-entropy between groups, contributing to improved fairness. Notably, in high-uncertainty scenarios, the labels are inherently noisy, causing predictions to resemble random assignments. This randomness leads to equal treatment of individual samples.

Consistency score 355 measures how a classifier 171 (see FIG. 1) treats its nearest neighbors, reflecting the influence of high aleatoric uncertainty, which introduces variability among the labels of neighboring samples. As this noise is theoretically irreducible, leveraging aleatoric uncertainty can pinpoint areas where consistency may be enhanced. This insight explains the observed empirical improvements in performance with respect to this metric.

In such a way, the techniques set forth herein utilize the connection between aleatoric uncertainty and fairness to provide the improved results demonstrated by the experiments, which specifically show how the disclosed techniques compare against both group and individual fairness. The experiments also suggest that the Attribute Label Shift (ALS) techniques described above introduce an improvement over the Label Shift (LS) techniques. In addition, experiments using GAIA framework 170 demonstrate that GAIA outperforms Bayesian Neural Networks consistently in terms of utility, while Bayesian Neural Networks have a minuscule advantage in terms of fairness. Bayesian Neural Networks have a coherent representation due to the regularization effect of the variational inference on the encoding space, where the encoder must output a probabilistic distribution over the latent variables that approximates the true posterior. This encourages similar samples to have similar encodings, leading to a more organized and smoother latent space representation. Therefore, it is not surprising that Bayesian Neural Networks demonstrate high performance on individual fairness metrics, as they evaluate the consistency in the treatment of similar covariates.

Both GAIA framework 170 and Bayesian Neural Networks outperform baseline approaches consistently in terms of the fairness-utility trade-off. Results over both image and tabular datasets show the generalizability of GAIA framework 170. GAIA framework 170 is further configurable utilizing different architectures. Sampling from a distribution over the model weights can also be used to measure uncertainty using GAIA framework 170.

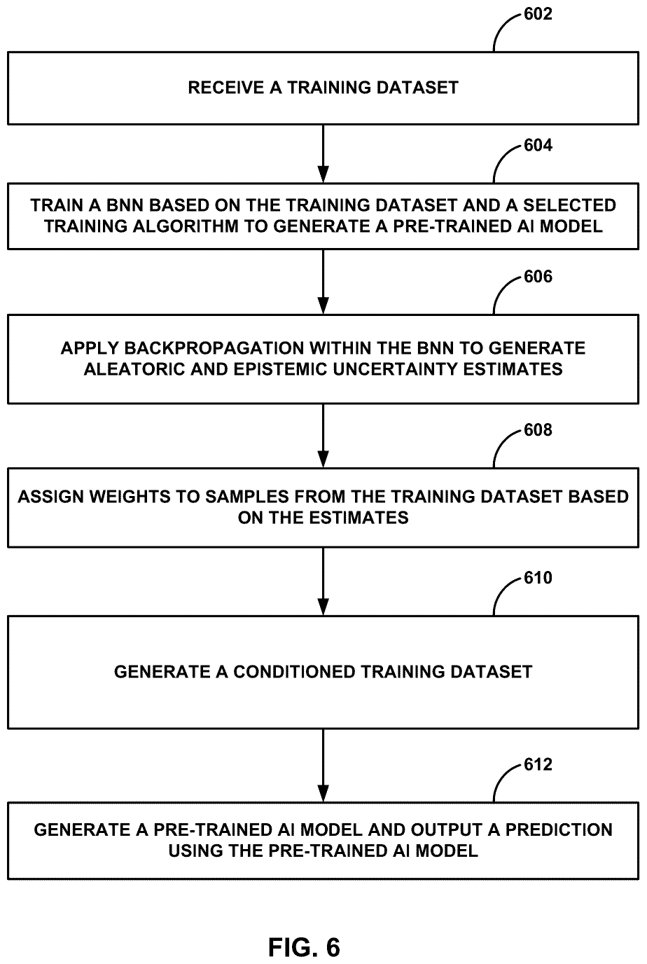

FIG. 6 is a flow diagram illustrating an example method for enhancing fairness-utility trade-off in classification tasks using aleatoric uncertainty, in accordance with one or more techniques of this disclosure. FIG. 6 is described with respect to computing device 100 and the processing circuitry of computing device 100 including at least processor(s) 102 and memory 104 FIG. 1 and the functions discussed in FIGS. 2A-2B in the context of FIGS. 3, 4, and 5. However, the techniques of FIG. 6 may be performed by different components of computing device 100 or by additional or alternative systems.

Processing circuitry may be configured to receive a training dataset (602). According to such an example, processing circuitry may be configured to Train a BNN based on the training dataset and a selected training algorithm to generate a pre-trained AI model (604). For instance, processing circuitry may be configured to train a Bayesian Neural Network (BNN) based on the training dataset and a selected training algorithm to generate a pre-trained artificial intelligence (AI) model, wherein the selected training algorithm includes backpropagation and weights for samples of the training dataset.

Continuing with such an example, processing circuitry may be configured to Apply backpropagation within the BNN to generate aleatoric and epistemic uncertainty estimates (606). For instance, processing circuitry may be configured to apply the backpropagation within the Bayesian Neural Network to generate aleatoric uncertainty estimates and epistemic uncertainty estimates for the samples from the training dataset. In some examples, processing circuitry is configured to assign weights to samples from the training dataset based on the estimates (608). For instance, processing circuitry may be configured to assign the weights to the samples from the training dataset based on the aleatoric uncertainty estimates and the epistemic uncertainty estimates for the samples from the training dataset. Processing circuitry may be configured to generate a conditioned training dataset (610). For instance, processing circuitry may be configured to generate a conditioned training dataset by increasing the weights assigned to the samples having the aleatoric uncertainty estimates below a threshold. In at least one example, processing circuitry is configured to generate a pre-trained AI model and output a prediction using the pre-trained AI model (612). For example, processing circuitry may be configured to generate the pre-trained artificial intelligence model trained using the conditioned training dataset as input and output a prediction using the pre-trained artificial intelligence model.

This disclosure includes the following examples.

Example 1—A method comprising: receiving, by processing circuitry, a training dataset; training, by the processing circuitry, a Bayesian Neural Network based on the training dataset and a selected training algorithm to generate a pre-trained artificial intelligence model, wherein the selected training algorithm includes backpropagation and weights for samples of the training dataset; applying, by the processing circuitry, the backpropagation within the Bayesian Neural Network to generate aleatoric uncertainty estimates and epistemic uncertainty estimates for the samples from the training dataset; assigning, by the processing circuitry, the weights to the samples from the training dataset based on the aleatoric uncertainty estimates and the epistemic uncertainty estimates for the samples from the training dataset; generating, by the processing circuitry, a conditioned training dataset by increasing the weights assigned to the samples having the aleatoric uncertainty estimates below a threshold; generating, by the processing circuitry, the pre-trained artificial intelligence model trained using the conditioned training dataset as input; and outputting a prediction using the pre-trained artificial intelligence model.

Example 2—The method of example 1, further comprising: receiving, by the processing circuitry, the training dataset including at least input features, labels, and a protected demographic attribute; and outputting, using the pre-trained artificial intelligence model, the prediction including a binary classification utilizing the protected demographic attribute.

Example 3—The method of example 1 or 2, further comprising: identifying one or more data biases in the training dataset based at least in part on skewed distributions of the labels within the training dataset and correlations between the protected demographic attribute and the skewed distributions of the labels.

Example 4—The method of any of examples 1-3, further comprising: generating the conditioned training dataset by batch modifying label distributions to adjust the skewed distributions of the labels within the training dataset and modifying the correlations between the protected demographic attribute and the skewed distributions of the labels within the training dataset.

Example 5—The method of any of examples 1-4, further comprising: performing distributional interventions on the training dataset to generate the conditioned training dataset using counterfactual batches generated from the samples of the training dataset; and modifying the skewed distributions of the labels within the training dataset and updating attribute-label correlations within the training dataset based on the skewed distributions of the labels within the training dataset modified.

Example 6—The method of any of examples 1-5, further comprising: increasing, by the processing circuitry, the weights assigned to the samples having the aleatoric uncertainty estimates below the threshold to maximize a measure of fairness-utility trade-off within the conditioned training dataset.

Example 7—The method of any of examples 1-6, wherein the aleatoric uncertainty estimates represent inherent randomness in the training dataset; and wherein the epistemic uncertainty estimates represent a quantified measure of lack of knowledge due to limited data within the training dataset.

Example 8—The method of any of examples 1-7, further comprising: assigning, by the processing circuitry, the weights to the samples from the training dataset using a weighting function, wherein the assigning, by the processing circuitry using a weighting function, higher weights to the samples from the training dataset with aleatoric uncertainty estimates below the threshold to balance between a fairness measure and a utility measure.

Example 9—The method of any of examples 1-8, further comprising: training a classifier on the conditioned training dataset to minimize a bi-objective loss function, wherein the bi-objective loss function includes: a utility loss term defined as a weighted cross-entropy loss, and a fairness loss term defined as a difference in mean cross-entropy losses between samples of the conditioned training dataset with different protected demographic attribute values.

Example 10—The method of any of examples 1-9, further comprising: generating the pre-trained artificial intelligence model trained using the conditioned training dataset as the input by adjusting the utility loss term and the fairness loss term to optimize a measure of fairness-utility trade-off for the pre-trained artificial intelligence model.

Example 11—The method of any of examples 1-10, further comprising: generating the aleatoric uncertainty estimates for the samples from the training dataset as expected entropy of predictions; and generating the epistemic uncertainty estimates for the samples from the training dataset as a variance of predictive probabilities across the samples from the training dataset.

Example 12—The method of any of examples 1-11, wherein the method further comprises: determining the aleatoric uncertainty estimates of the samples from the training dataset according to an expression: Hₐₗₑₐ(x)=∫_{θ}Σᵢ^{C}−p(yᵢ|x,θ)log p(yᵢ|x,θ)dθ, wherein p(yᵢ|x,θ) represents predictive probability of an i-th class, C, from the pre-trained artificial intelligence model parameterized by θ.

Example 13—A system comprising: processing circuitry; non-transitory computer readable media; and instructions that, when executed by the processing circuitry, configure the processing circuitry to: receive, by the processing circuitry, a training dataset; train, by the processing circuitry, a Bayesian Neural Network based on the training dataset and a selected training algorithm to generate a pre-trained artificial intelligence model, wherein the selected training algorithm includes backpropagation and weights for samples of the training dataset; apply, by the processing circuitry, the backpropagation within the Bayesian Neural Network to generate aleatoric uncertainty estimates and epistemic uncertainty estimates for the samples from the training dataset; assign, by the processing circuitry, the weights to the samples from the training dataset based on the aleatoric uncertainty estimates and the epistemic uncertainty estimates for the samples from the training dataset; generate, by the processing circuitry, a conditioned training dataset by increasing the weights assigned to the samples having the aleatoric uncertainty estimates below a threshold; generate, by the processing circuitry, the pre-trained artificial intelligence model trained using the conditioned training dataset as input; and output a prediction using the pre-trained artificial intelligence model.

Example 14—The system of example 13, wherein the instructions, when executed by the processing circuitry, further configure the processing circuitry to: receive, by the processing circuitry, the training dataset including at least input features, labels, and a protected demographic attribute; and output, by the processing circuitry using the pre-trained artificial intelligence model, the prediction including a binary classification utilizing the protected demographic attribute.

Example 15—The system of example 13 or 14, wherein the instructions, when executed by the processing circuitry, further configure the processing circuitry to: identify one or more data biases in the training dataset based at least in part on skewed distributions of the labels within the training dataset and correlations between the protected demographic attribute and the skewed distributions of the labels.

Example 16—The system of any of examples 13-15, wherein the instructions, when executed by the processing circuitry, further configure the processing circuitry to: generate the conditioned training dataset by batch modifying label distributions to adjust the skewed distributions of the labels within the training dataset and modifying the correlations between the protected demographic attribute and the skewed distributions of the labels within the training dataset.

Example 17—The system of any of examples 13-16, wherein the instructions, when executed by the processing circuitry, further configure the processing circuitry to: increase, by the processing circuitry, the weights assigned to the samples having the aleatoric uncertainty estimates below the threshold to maximize a measure of fairness-utility trade-off within the conditioned training dataset.

Example 18—The system of any of examples 13-17, wherein the instructions, when executed by the processing circuitry, further configure the processing circuitry to: assign, by the processing circuitry, the weights to the samples from the training dataset using a weighting function, wherein the assigning, by the processing circuitry using a weighting function, higher weights to the samples from the training dataset with aleatoric uncertainty estimates below the threshold to balance between a fairness measure and a utility measure.

Example 19—The system of any of examples 13-18, wherein the instructions, when executed by the processing circuitry, further configure the processing circuitry to: train a classifier on the conditioned training dataset to minimize a bi-objective loss function, wherein the bi-objective loss function includes: a utility loss term defined as a weighted cross-entropy loss, and a fairness loss term defined as a difference in mean cross-entropy losses between samples of the conditioned training dataset with different protected demographic attribute values; and generate the pre-trained artificial intelligence model trained using the conditioned training dataset as the input by adjusting the utility loss term and the fairness loss term to optimize a measure of fairness-utility trade-off for the pre-trained artificial intelligence model.

Example 20—Computer-readable storage media comprising instructions that, when executed, configure processing circuitry to: receive a training dataset; train a Bayesian Neural Network based on the training dataset and a selected training algorithm to generate a pre-trained artificial intelligence model, wherein the selected training algorithm includes backpropagation and weights for samples of the training dataset; apply the backpropagation within the Bayesian Neural Network to generate aleatoric uncertainty estimates and epistemic uncertainty estimates for the samples from the training dataset; assign the weights to the samples from the training dataset based on the aleatoric uncertainty estimates and the epistemic uncertainty estimates for the samples from the training dataset; generate a conditioned training dataset by increasing the weights assigned to the samples having the aleatoric uncertainty estimates below a threshold; generate the pre-trained artificial intelligence model trained using the conditioned training dataset as input; and output a prediction using the pre-trained artificial intelligence model.

Example 21—A computer program product comprising one or more instructions that, when executed by at least one processor, cause the at least one processor to perform any of the methods of examples 1-12.

Example 22—A device comprising means for performing any of the methods of examples 1-12.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
receiving, by processing circuitry, a training dataset;
training, by the processing circuitry, a Bayesian Neural Network based on the training dataset and a selected training algorithm to generate a pre-trained artificial intelligence model, wherein the selected training algorithm includes backpropagation and weights for samples of the training dataset;
applying, by the processing circuitry, the backpropagation within the Bayesian Neural Network to generate aleatoric uncertainty estimates and epistemic uncertainty estimates for the samples from the training dataset;
assigning, by the processing circuitry, the weights to the samples from the training dataset based on the aleatoric uncertainty estimates and the epistemic uncertainty estimates for the samples from the training dataset;
generating, by the processing circuitry, a conditioned training dataset by increasing the weights assigned to the samples having the aleatoric uncertainty estimates below a threshold;
generating, by the processing circuitry, the pre-trained artificial intelligence model trained using the conditioned training dataset as input; and
outputting a prediction using the pre-trained artificial intelligence model.

2. The method of claim 1, further comprising:
receiving, by the processing circuitry, the training dataset including at least input features, labels, and a protected demographic attribute; and
outputting, using the pre-trained artificial intelligence model, the prediction including a binary classification utilizing the protected demographic attribute.

3. The method of claim 2, further comprising:
identifying one or more data biases in the training dataset based at least in part on skewed distributions of the labels within the training dataset and correlations between the protected demographic attribute and the skewed distributions of the labels.

4. The method of claim 3, further comprising:
generating the conditioned training dataset by batch modifying label distributions to adjust the skewed distributions of the labels within the training dataset and modifying the correlations between the protected demographic attribute and the skewed distributions of the labels within the training dataset.

5. The method of claim 3, further comprising:
performing distributional interventions on the training dataset to generate the conditioned training dataset using counterfactual batches generated from the samples of the training dataset; and
modifying the skewed distributions of the labels within the training dataset and updating attribute-label correlations within the training dataset based on the skewed distributions of the labels within the training dataset modified.

6. The method of claim 1, further comprising:
increasing, by the processing circuitry, the weights assigned to the samples having the aleatoric uncertainty estimates below the threshold to maximize a measure of fairness-utility trade-off within the conditioned training dataset.

7. The method of claim 1:
wherein the aleatoric uncertainty estimates represent inherent randomness in the training dataset; and
wherein the epistemic uncertainty estimates represent a quantified measure of lack of knowledge due to limited data within the training dataset.

8. The method of claim 1, further comprising:
assigning, by the processing circuitry, the weights to the samples from the training dataset using a weighting function, wherein the
assigning, by the processing circuitry using a weighting function, higher weights to the samples from the training dataset with aleatoric uncertainty estimates below the threshold to balance between a fairness measure and a utility measure.

9. The method of claim 1, further comprising:
training a classifier on the conditioned training dataset to minimize a bi-objective loss function, wherein the bi-objective loss function includes:
a utility loss term defined as a weighted cross-entropy loss, and
a fairness loss term defined as a difference in mean cross-entropy losses between samples of the conditioned training dataset with different protected demographic attribute values.

10. The method of claim 9, further comprising:
generating the pre-trained artificial intelligence model trained using the conditioned training dataset as the input by adjusting the utility loss term and the fairness loss term to optimize a measure of fairness-utility trade-off for the pre-trained artificial intelligence model.

11. The method of claim 1, further comprising:
generating the aleatoric uncertainty estimates for the samples from the training dataset as expected entropy of predictions; and
generating the epistemic uncertainty estimates for the samples from the training dataset as a variance of predictive probabilities across the samples from the training dataset.

12. The method of claim 1, wherein the method further comprises:
determining the aleatoric uncertainty estimates of the samples from the training dataset according to an expression:
$${H}_{alea} ( x ) = {\int }_{θ} {\sum }_{i}^{C} - p ( {y}_{i} \vert x , θ ) log p ( {y}_{i} \vert x , θ ) d θ ,$$
wherein p(yᵢ|x,θ) represents predictive probability of an i-th class, C, from the pre-trained artificial intelligence model parameterized by θ.

13. A system comprising:
processing circuitry;
non-transitory computer readable media; and
instructions that, when executed by the processing circuitry, configure the processing circuitry to:
receive, by the processing circuitry, a training dataset;
train, by the processing circuitry, a Bayesian Neural Network based on the training dataset and a selected training algorithm to generate a pre-trained artificial intelligence model, wherein the selected training algorithm includes backpropagation and weights for samples of the training dataset;
apply, by the processing circuitry, the backpropagation within the Bayesian Neural Network to generate aleatoric uncertainty estimates and epistemic uncertainty estimates for the samples from the training dataset;
assign, by the processing circuitry, the weights to the samples from the training dataset based on the aleatoric uncertainty estimates and the epistemic uncertainty estimates for the samples from the training dataset;
generate, by the processing circuitry, a conditioned training dataset by increasing the weights assigned to the samples having the aleatoric uncertainty estimates below a threshold;
generate, by the processing circuitry, the pre-trained artificial intelligence model trained using the conditioned training dataset as input; and
output a prediction using the pre-trained artificial intelligence model.

14. The system of claim 13, wherein the instructions, when executed by the processing circuitry, further configure the processing circuitry to:
receive, by the processing circuitry, the training dataset including at least input features, labels, and a protected demographic attribute; and
output, by the processing circuitry using the pre-trained artificial intelligence model, the prediction including a binary classification utilizing the protected demographic attribute.

15. The system of claim 14, wherein the instructions, when executed by the processing circuitry, further configure the processing circuitry to:
identify one or more data biases in the training dataset based at least in part on skewed distributions of the labels within the training dataset and correlations between the protected demographic attribute and the skewed distributions of the labels.

16. The system of claim 15, wherein the instructions, when executed by the processing circuitry, further configure the processing circuitry to:
generate the conditioned training dataset by batch modifying label distributions to adjust the skewed distributions of the labels within the training dataset and modifying the correlations between the protected demographic attribute and the skewed distributions of the labels within the training dataset.

17. The system of claim 13, wherein the instructions, when executed by the processing circuitry, further configure the processing circuitry to:
increase, by the processing circuitry, the weights assigned to the samples having the aleatoric uncertainty estimates below the threshold to maximize a measure of fairness-utility trade-off within the conditioned training dataset.

18. The system of claim 13, wherein the instructions, when executed by the processing circuitry, further configure the processing circuitry to:
assign, by the processing circuitry, the weights to the samples from the training dataset using a weighting function, wherein the
assign, by the processing circuitry using a weighting function, higher weights to the samples from the training dataset with aleatoric uncertainty estimates below the threshold to balance between a fairness measure and a utility measure.

19. The system of claim 13, wherein the instructions, when executed by the processing circuitry, further configure the processing circuitry to:
train a classifier on the conditioned training dataset to minimize a bi-objective loss function, wherein the bi-objective loss function includes:
a utility loss term defined as a weighted cross-entropy loss, and
a fairness loss term defined as a difference in mean cross-entropy losses between samples of the conditioned training dataset with different protected demographic attribute values; and
generate the pre-trained artificial intelligence model trained using the conditioned training dataset as the input by adjusting the utility loss term and the fairness loss term to optimize a measure of fairness-utility trade-off for the pre-trained artificial intelligence model.

20. Computer-readable storage media comprising instructions that, when executed, configure processing circuitry to:
receive a training dataset;
train a Bayesian Neural Network based on the training dataset and a selected training algorithm to generate a pre-trained artificial intelligence model, wherein the selected training algorithm includes backpropagation and weights for samples of the training dataset;
apply the backpropagation within the Bayesian Neural Network to generate aleatoric uncertainty estimates and epistemic uncertainty estimates for the samples from the training dataset;
assign the weights to the samples from the training dataset based on the aleatoric uncertainty estimates and the epistemic uncertainty estimates for the samples from the training dataset;
generate a conditioned training dataset by increasing the weights assigned to the samples having the aleatoric uncertainty estimates below a threshold;
generate the pre-trained artificial intelligence model trained using the conditioned training dataset as input; and
output a prediction using the pre-trained artificial intelligence model.
